(19) United States
(12) Patent Application Publication
(10) Pub. No.: US 2024/0065240 A1
(43) Pub. Date: Feb. 29, 2024

(54) FISHING LURE GRAPHIC APPLICATION ASSEMBLY AND METHOD

(71) Applicant: Benjamin James Kirk, Brooklyn Park, MN (US)

(72) Inventor: Benjamin James Kirk, Brooklyn Park, MN (US)

(21) Appl. No.: 17/894,670

(22) Filed: Aug. 24, 2022

(51) Int. Cl. A01K 85/00; B05D 5/06

(52) U.S. Cl. CPC A01K 85/1897; B05D 5/06

(57) ABSTRACT

A fishing lure graphic application assembly includes a reservoir having a bottom wall and a perimeter wall that attached to and extends upwardly from the bottom wall. A dipping system is positioned adjacent to the reservoir and engages a fishing lure blank and a dissolvable film, places the dissolvable film in a quantity of water positioned in the reservoir such that graphic is released onto a surface of the water, extend the fishing lure blank through the graphic such that the graphic adheres to the fishing lure blank, and lifts the fishing lure blank upwardly out of the water.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fishing lure graphic applying system and more particularly pertains to a new fishing lure graphic applying system for adding decorative elements to a fishing lure blank. Specifically, the invention allows a user to print out pre-paired or personally created graphics on a dissolvable medium with a conventional inkjet printer and to apply that graphic to the fishing lure blank with a mechanized assembly. The assembly evenly and efficiently applies the graphic to the fishing lure blank in such a manner that the result is an aesthetically pleasing fishing lure.

### (2) Description of Related Art Including Information Disclosed Under 37 CFR 1.97 and 1.98

The prior art relates to fishing lure graphic applying systems and methods that require lure preparer to utilize one of two well defined pathways. The first pathway involves the lure preparer to paint, by hand, the designs and colorations on a fishing lure blank. Since fishing lure graphics are often reminiscent of small fish, the painting by hand of fine details is exceedingly tedious and easily blemished. Further, the success of this method is highly dependent upon the painting and creative skills of the painter. The second pathway utilizes decals that are lifted or slid from a base panel and then placed on the fishing lure blank. While this method removes the tediousness and risk of error associated with painting, the decals are not easily manipulated into place, can tear or wrinkle easily, and are difficult to position such that no seams are visible since each fishing lure blank normally requires one decal for each side and the edges of the decals rarely align with each other perfectly.

The current assembly solves the problems above by utilizing a printed graphic that is applied to the fishing lure blank in an automated manner that does not require one to be a highly skilled painter or to be concerned about aesthetically pleasing graphic coverage. The assembly of the current invention does this by ensuring that the graphic is lined up properly with the fishing lure blank and that the fishing lure blank is moved through the graphic at a correct position.

### BRIEF SUMMARY OF THE INVENTION

An embodiment of the disclosure meets the needs presented above by generally comprising a reservoir having a bottom wall and a perimeter wall that attached to and extends upwardly from the bottom wall. A dipping system is positioned adjacent to the reservoir and engages a fishing lure blank and a dissolvable film, places the dissolvable film in a quantity of water positioned in the reservoir such that graphic is released onto a surface of the water, extend the fishing lure blank through the graphic such that the graphic adheres to the fishing lure blank, and lifts the fishing lure blank upwardly out of the water.

Another embodiment of disclosure includes a method of positioning a graphic on a fishing lure blank. This method includes positioning the fishing lure blank on a coupler of a lure arm and positioning a dissolvable film, having a graphic printed thereon, on a frame attached to a film arm. The film and lure arms are each is attached to a drive assembly of a dipping system. The film arm is moved to a lowered position to dip the dissolvable film into water positioned in a reservoir until the dissolvable film releases the graphic such that the graphic is positioned on a surface of the water. The lure arm is then moved from a first position having the coupler and fishing lure blank positioned outside of the water to a second position having the fishing lure blank positioned in the water such that the fishing lure blank moves through the graphic and the graphic adheres to the fishing lure blank. The lure arm is thereafter moved toward a second position such that the fishing lure blank is positioned outside of the water.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded, top isometric view of a fishing lure graphic application assembly and method according to an embodiment of the disclosure.

FIG. 2 is a front isometric view of an embodiment of the disclosure.

FIG. 3 is a rear isometric view of an embodiment of the disclosure.

FIG. 4 is a top view of an embodiment of the disclosure.

FIG. 5 is a cross-sectional view of an embodiment of the disclosure taken along line 5-5 of FIG. 4.

FIG. 6 is a bottom isometric view of an embodiment of the disclosure showing a graphic positioned on a dissolvable film to be mounted on a frame.

FIG. 7 is a front in-use view of an embodiment of the disclosure showing the frame positioned in a reservoir.

FIG. 8 is a front in-use view of an embodiment of the disclosure depicting a fishing lure blank extending through the frame and into the reservoir.

FIG. 9 is a side view of an embodiment of the disclosure.

FIG. 10 is a side broken view of an embodiment of the disclosure.

FIG. 11 is a view of an embodiment of the disclosure.

### DETAILED DESCRIPTION OF THE INVENTION

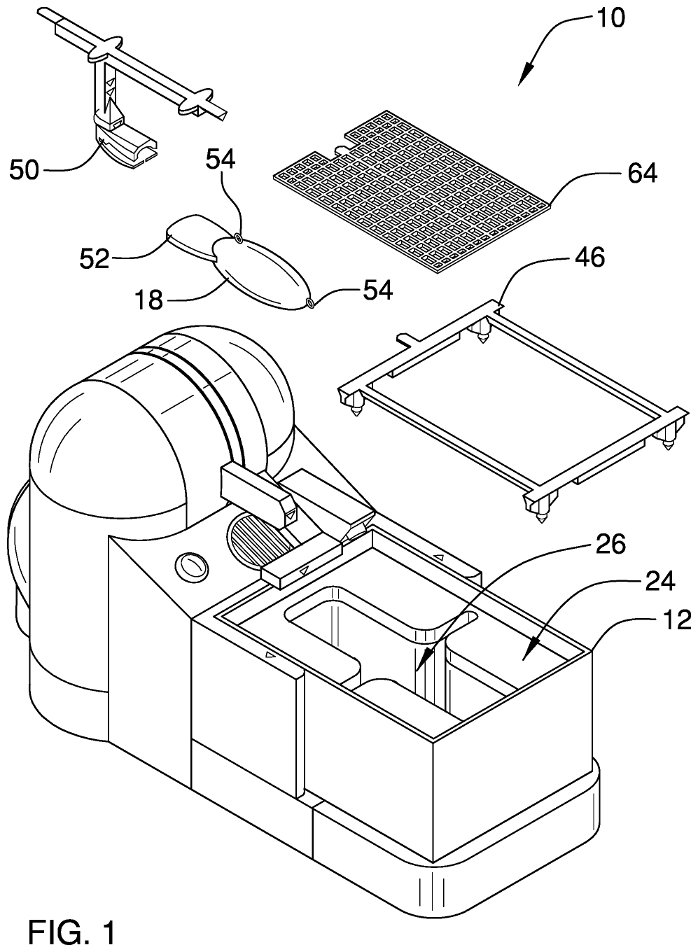

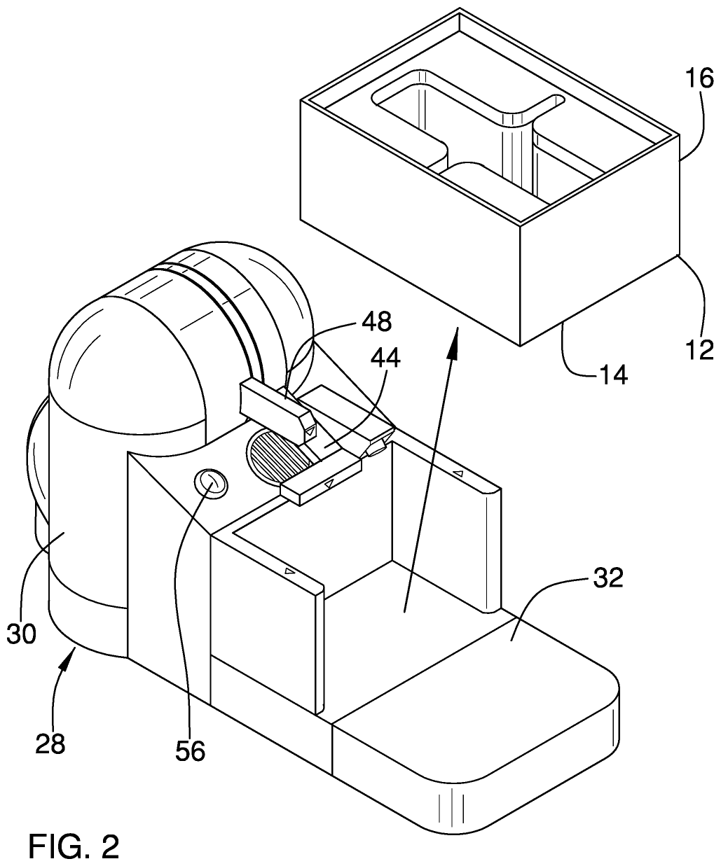

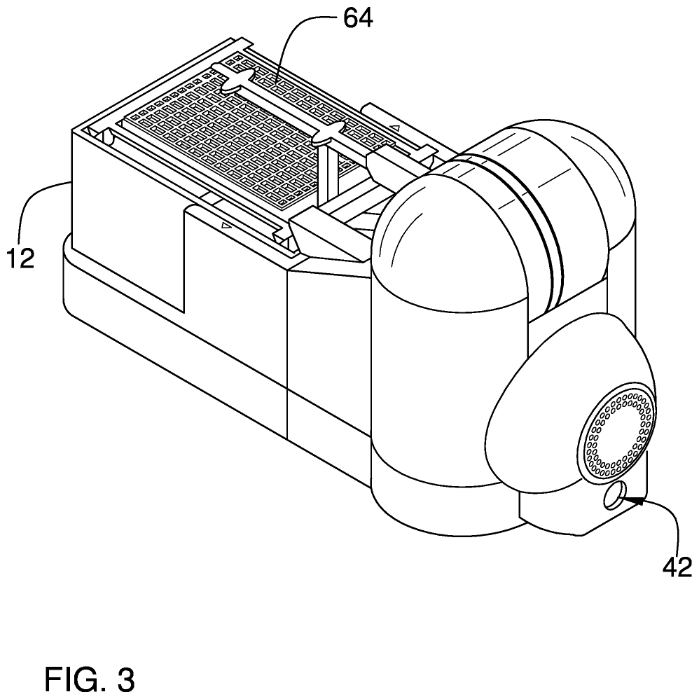

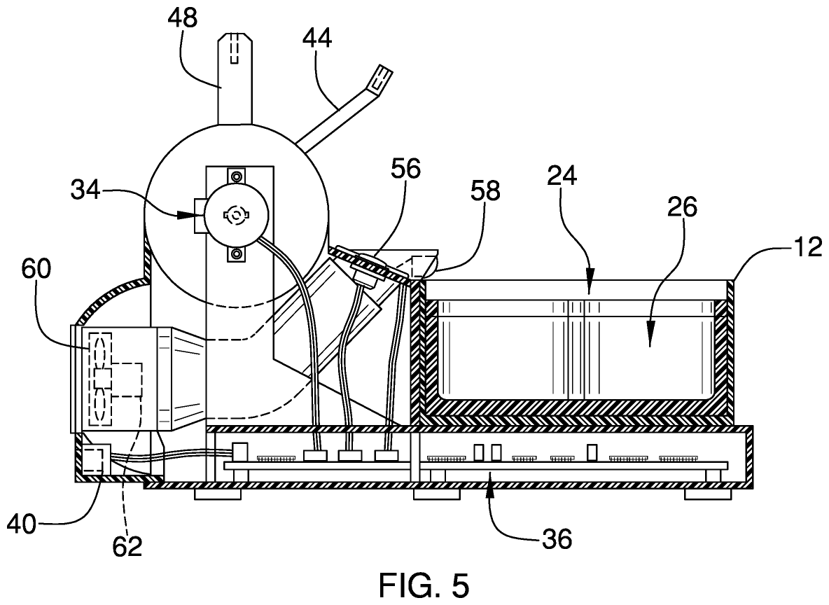

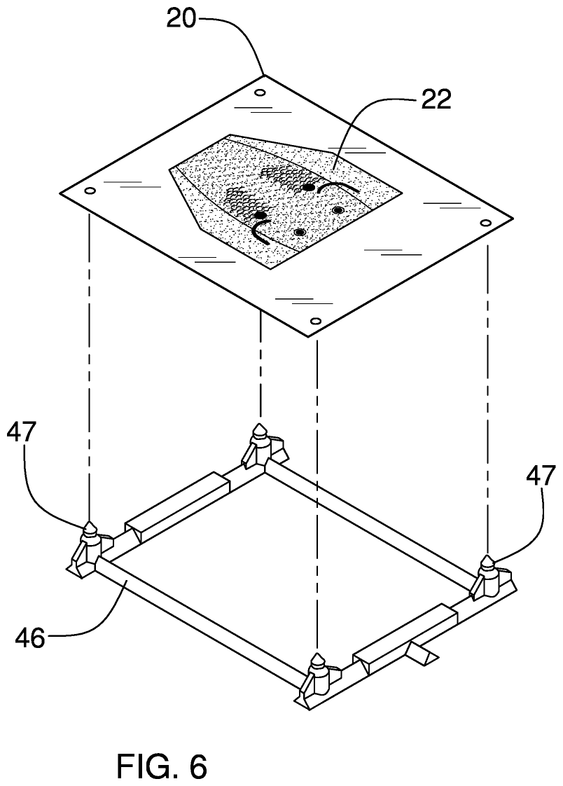

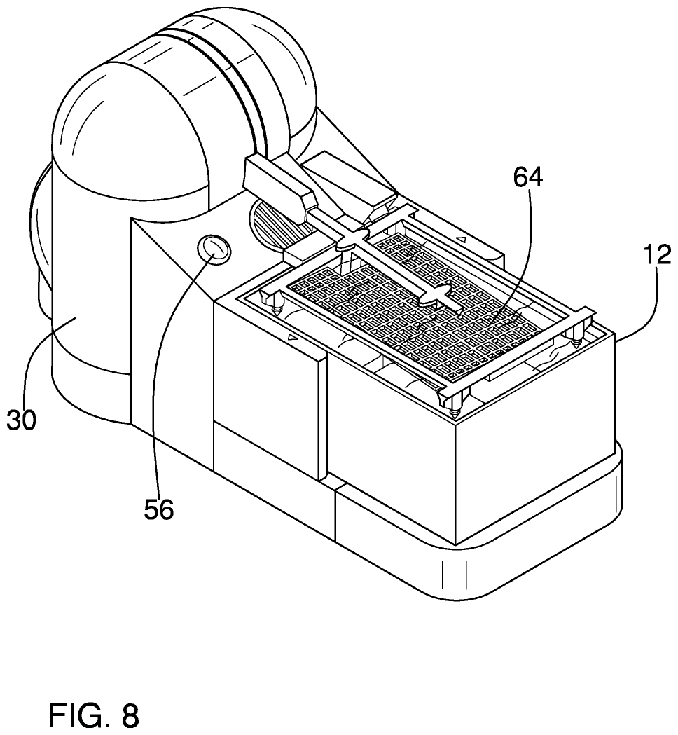

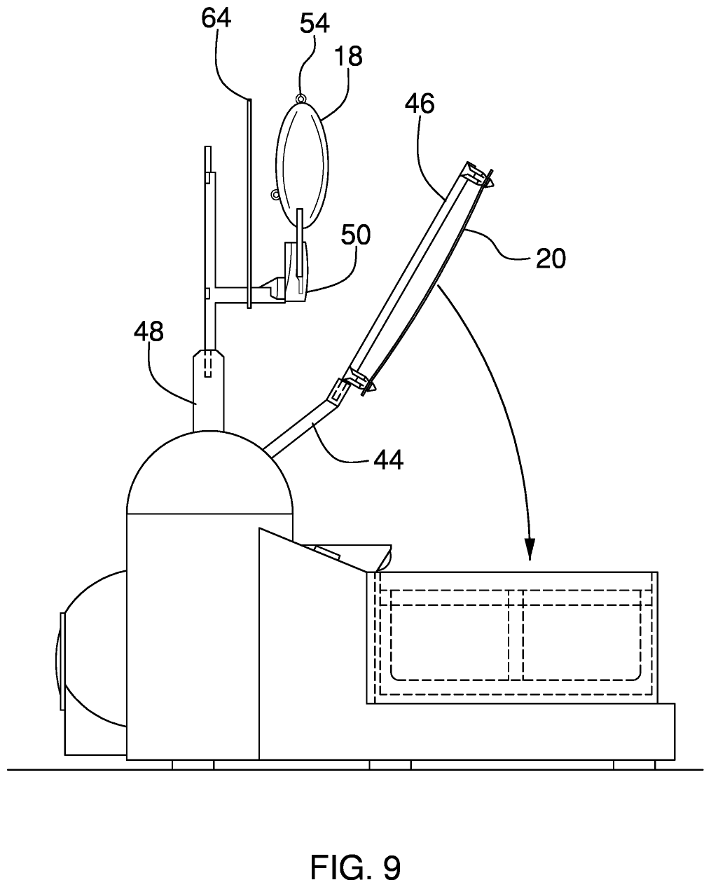

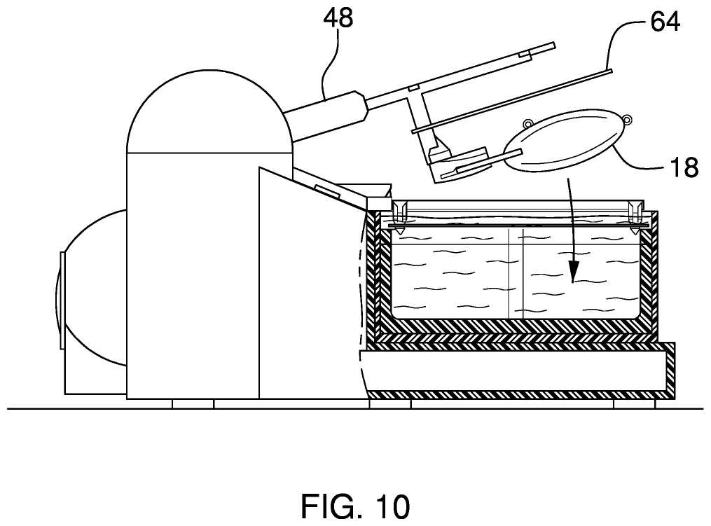

With reference now to the drawings, and in particular to FIGS. 1 through 11 thereof, a new fishing lure graphic applying system embodying the principles and concepts of an embodiment of the disclosure and generally designated by the reference numeral 10 will be described.

As best illustrated in FIGS. 1 through 11, the fishing lure graphic application assembly 10 and method generally includes a reservoir 12 having a bottom wall 14 and a perimeter wall 16 that is attached to and extends upwardly from the bottom wall 14. The reservoir 12 will typically have a interior depth of 3.0 inches to 12.0 inches, a width of 2.0 inches to 8.0 inches, and a length of 4.0 inches to 12.0 inches. These measurements are preferred as they will adequately accommodate a fishing lure blank 18. While only one type of fishing lure blank 18 is shown in FIG. 1, it is understood that the assembly and method taught herein may be used with variously shaped fishing lure blanks 18. The fishing lure blanks 18 are conventional fishing lures which have yet to be marked within any indicia, including, in particular, coloration and design elements considered beneficial for attracting fish.

The assembly 10 and method further makes use of dissolvable film 20 having a graphic 22 printed thereon. “Dissolvable” in this sense will typically include being soluble in water. Within this document the terms “film” and “dissolvable film” are used interchangeably and are indicative of the same element. Such films 20 are conventional and allow printing of the graphic 22 on the film 20. In some examples of these films 20, an activator is applied to the graphic 22 after the graphic 22 dries to protect the ink used to create the graphic 22. The film 20 is then placed in water and a second activator is applied causing the film 20 to dissolve into the water leaving only the ink from the printed graphic on the surface of the water. However, it should be understood that in certain embodiments one, both, or neither of activators may be needed and therefore may be eliminated. The films 20 usually include a backing panel of paper or flexible plastic which is used to support the film as it is being pulled through a printer and is removed before the film 20 is be placed in water. As stated above, such films 20 are conventional and may be referred to as “hydrographic film” or “water transfer printing film”.

The reservoir 12 may include an upper portion 24 having a greater width than a lower portion 26 wherein the graphic 22 is also wider than the lower portion 26. As will be described more fully below, when the fishing lure blank 18 is extended through the upper portion 24 and into the lower portion 26, the shape of the reservoir 12 ensures that the graphic 22 envelopes the fishing lure blank 18.

A dipping system 28 is positioned adjacent to the reservoir 12. Generally, in an automated manner, the dipping system 28 is configured to engage the fishing lure blank 18 and the printed film 20, place the film 20 in a quantity of water positioned in the reservoir 12 such that graphic 22 is released onto a surface of the water, extend the fishing lure blank 18 through the graphic 22 to adhere the graphic to the fishing lure blank 18, and lift the fishing lure blank 18 upwardly out of the water.

More particularly, the dipping system 28 includes a housing 30 to support the various elements of the dipping system 28 and to contain its electronic components. In one embodiment, a platform 32 is attached to the housing 30 and forms a saddle for removably receiving the reservoir 12. However, it should be understood that the reservoir 12 may be integral to the housing 30 and form a unitary structure with the housing 30. The ability to remove the reservoir 12 facilitates cleaning and filling of the reservoir 12.

Within the housing 30 is mounted a drive assembly 34 and a control circuit 36 electrically coupled to the drive assembly 34. The control circuit 36 is conventional and is programmable. The control circuit 36 may include circuit board for the supporting and interconnecting of programmable processors and memory modules. The drive assembly 34 may include, for example, one or more electric motors 38 or solenoids. A power supply 40 is electrically coupled to the control circuit 36 and may include a conventional plug for connection to an electrical outlet and/or may include a battery mounted within the housing. The battery may be rechargeable and include a power port 42 extending through a wall of the housing 30 to recharge the battery as needed.

A film arm 44 is attached to the drive assembly 34 and to the film arm 44 is attached a frame 46. As can be seen in the Figures, the frame 46 may have a rectangular shape and is configured to engage the dissolvable film 20. To this end, the frame 46 may include prongs 47 or other connectors for coupling the film 20 to the frame 46. The film may include pre-punched holes for receiving the prongs 47 to ensure that the film 20 is in the proper position relative to the reservoir 12. The prongs 47 prevent the film 20 from curling and will typically support the film 20 so that a side of the film 20 facing the reservoir is convexly shaped to push away any air bubbles that might otherwise form between the film 20 and the water. As can be seen in FIG. 1, the frame 46 has a greater width than the lower portion 26 to retain the film 20 in the upper portion 24 which forms the shallow section of the reservoir 12. The drive assembly 34 moves the frame 46 from a lifted position for supporting the dissolvable film 20 above the reservoir to a lowered position extending the dissolvable film 20 into the reservoir 12 and the water.

In one exemplary embodiment, the prongs 47 have pointed tips and the prongs 47 extend into the water in the reservoir 12, when in the lowered position, no greater than 5.0 mm and comprise the only portion of the frame 46 coming in contact with the water. The combined effect of the prongs 47 being pointed and extending into the water no greater than 5.0 mm ensures that ripples are not formed in the water which could lead to air bubbles positioned under the film 20. While the film 20 of the type used with the assembly 10 typically expands when placed in contact with the water, the prongs 47 retain the graphic in a correct position in the reservoir 12. Additionally, a perimeter of the reservoir 12 may be sized to contain the expansion of the film 20.

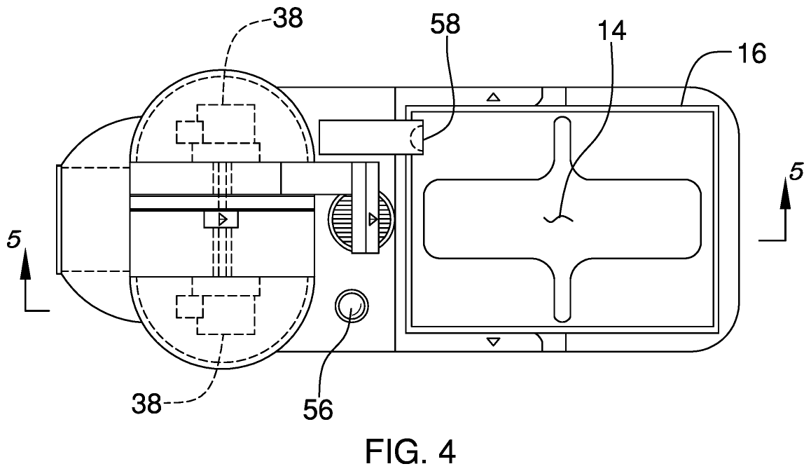

A lure arm 48 is also attached to the drive assembly 24. As can be seen in FIG. 4, the drive assembly 24 may include one motor 38 for the film arm 44 and a second motor 38 for the lure arm 48, though the same independent movement of the film 44 and lure 46 arms may be accomplished with mechanical gearing. A coupler 50 is mounted on the lure arm 48 to releasably engage the fishing lure blank 18. The coupler 50 may vary depending on the type of fishing lure blank 48 receiving the graphic 22. In one example the coupler 50 is a sleeve or clip to frictionally engage a diving bill 52 attached to the fishing lure blank 18 but can also comprise a mechanical clamp to grip eyelets 54 or other areas of a fishing lure blank 18. The drive assembly 24 moves the coupler 50 from a first position above the reservoir 12 and a plane of the surface of the water to a second position into the reservoir 12 and below the plane of the surface of the water. More particularly, the coupler 50 may extend into the lower portion 26 of the reservoir 12.

An actuator 56 is operationally coupled to the control circuit 36 and a dipping sequence is initiated when the actuator 56 is engaged. As shown in the Figures, the actuator 56 in some embodiments comprises a mechanical switch positioned on the housing 30. Other embodiments may include wireless controls including Bluetooth and WiFi enabled controls allowing a user to actuate the assembly 10 with a dedicated remote control or by way of a cellular phone application. These embodiments would therefore include a wireless receiver electrically coupled to the control circuit 36. Instead of a mechanical switch, a touch screen may instead be employed to function as the actuator and which may additionally provide information to the user of the assembly 10 including relevant time frames and temperatures relating to the use of the assembly 10.

The control circuit 36 is programmed to complete a plurality of lure 48 and film 44 arm positionings of the dipping sequence. The lure 48 and film 44 arm positioning includes first moving the film arm 44 to the lowered position and second moving the lure arm 48 to the second position. The lure arm 48 is moved to the second position only after a predetermined dissolving time has elapsed, and a time the coupler 50 is in the second position defines a dipping time. The control circuit 36 is programmed to move the lure arm 48 to the first position after a dipping time has elapsed. The dipping time is typically very short as there is often little need to retain the lure arm 48 in the second position after the graphic 22 has been applied to the fishing lure blank 18. Though the fishing lure blank 18, after receiving the graphic 22, is no longer, from a technical perspective, a “fishing lure blank” and instead is a “painted fishing lure”, the term “fishing lure blank” will be utilized throughout for clarity. In some embodiments, the drive assembly 34 is configured to oscillate the coupler 50 and fishing lure blank 18 up and down above the reservoir 12 a plurality of times after the dipping time has elapsed to facilitate removal of excess water. The number of times the lure arm 24 oscillates is typically between 2 and oscillations.

A temperature sensor 58 may be utilized to measure a temperature of the water within the reservoir 12 and is electrically coupled to the control circuit 36. The purpose for the temperature sensor 58 is to assist in calibrating the dissolving time. Since the film will typically dissolve faster, relative to a base temperature, in warmer water than in colder water, the dissolving time must be adjusted according to the temperature of the water. The control circuit 36 is programmed to alter the dissolving time dependent upon the temperature of the water. As the type of film 20 used could alter the dissolving time as well, the control circuit 36 may be programmable to allow a user of the assembly 10 to manually adjust the dissolving time as needed, or allow for the entering of information related to the film 20 being used wherein the control assembly 36 will automatically adjust the dissolving time based upon a database of known dissolving times associated with each type of film correlated to specific water temperatures. In one embodiment, the temperature sensor 58 comprises an infrared temperature sensor mounted on the housing and which is directed toward the reservoir 12.

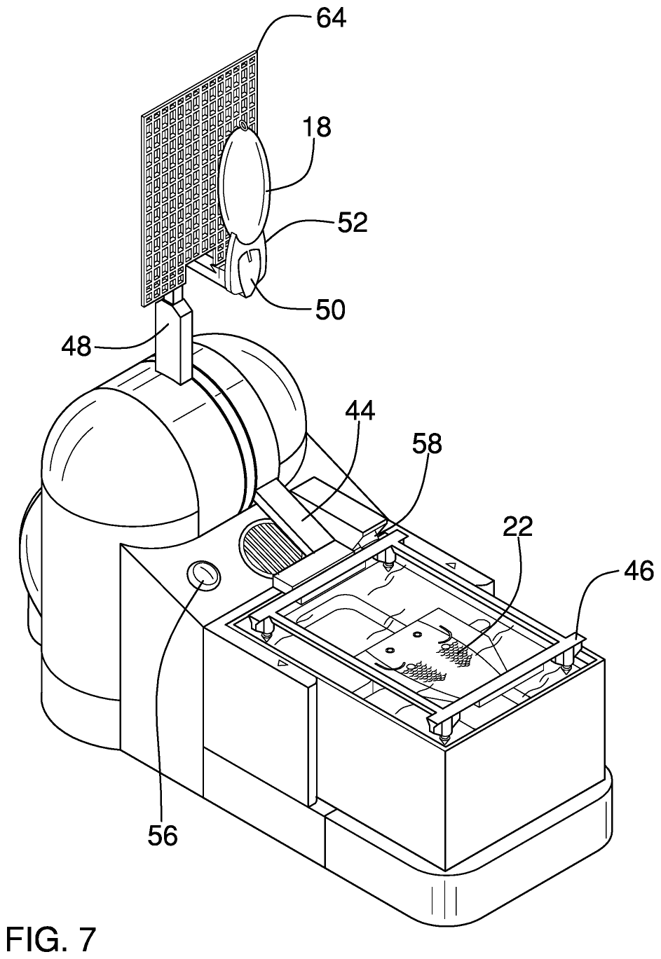

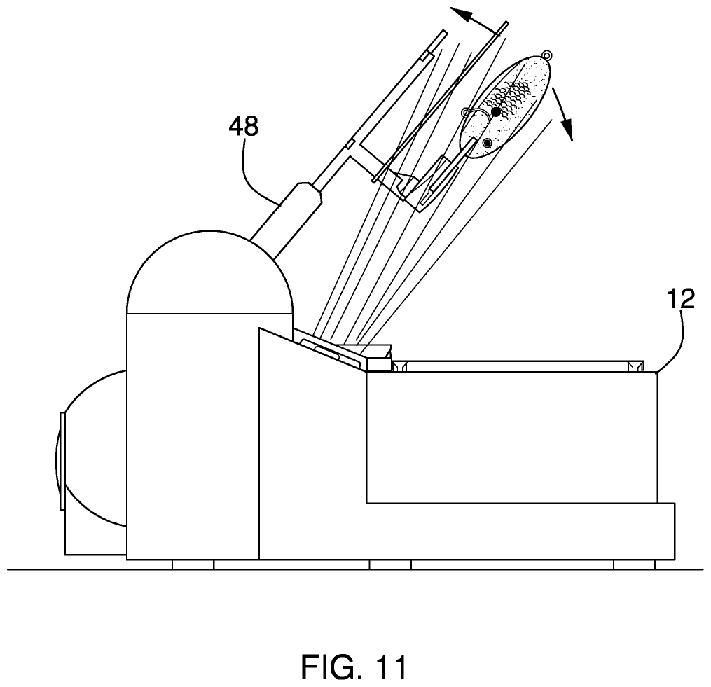

A blower 60 is mounted in the housing 30 and directs air toward the coupler 52 when turned on for a predetermined time. The blower 60 is electrically coupled to the control circuit 36 and is turned on when the coupler 52 is lifted from the reservoir 12. The blower 60 may further including a heat element to warm the air being ejected by the blower 60. The control circuit 36 may be programmed such that the first position includes various stages between holding the fishing lure blank 18 just out of the reservoir 12 as shown in FIG. 11 and holding the fishing lure blank 18 in a vertical orientation as seen in FIG. 7. This allows for a temporary but static angled orientation over the reservoir 12 while the blower 60 is moving air over the fishing lure blank 18 to dry and cure the graphic 22 in place. Further the lure arm 48 may be oscillating while the blower 60 is turned on. The blower 60 may utilize an electrically powered motor 62 driving a propeller or impeller as is found in a typical handheld hair dryer.

A screen 64 is positioned on the lure arm 48 and positioned such that the coupler 50 is located below the screen 64 when the coupler 50 is within the reservoir 12. The screen 64 is placed within the reservoir 12 when the lure arm 48 is in the second position and is configured to capture and remove residue floating in the reservoir 12. This residue may include portions of the graphic 22 which did not adhere to the fishing lure blank 18 as the graphic 22 may be larger than the fishing lure blank 18 to ensure complete coverage and may further include free floating ink globules. The residue may also compose portions of un-dissolved film 20 floating on the water surface. As can be seen in the Figures, the screen 64 may be attached adjacent to the lure arm 48 while the coupler 50 may be offset from the lure arm 48. This positioning of the coupler 50 also ensures full immersion of the fishing lure blank 18 in the reservoir 12.

In use of an exemplary embodiment, the user of the 10 assembly will attach a fishing lure blank 18 to the coupler 50 and the dissolvable film 20 on the frame 46. The film 20 will, of course, already have had the graphic 22 printed thereon. When the actuator 56 initiates the dipping sequence, the film arm 44 is rotated about an axis of between 30° and 90° to place the film 20 on the surface of the water. As mentioned, activators may be used but in other instances the water itself will dissolve the film 20 sufficiently such that no activator is required. The frame 46 may be constructed and the film 20 sized such that a top side of the film 20, when positioned on the water, is slightly concave to ensure that portion of the film 20 adjacent to and abutting the graphic 22 is in contact with the water. More particularly, by having a bottom surface of the film 20 being convex, air bubbles are prevented from forming between the film 20 and the water.

Upon elapsing of the dissolve time, the lure arm 48 will rotate about an axis of between 30° and 110° to cause the fishing lure blank 18 to move through the graphic 22, now floating on the surface of the water, such that the graphic 22 abuts and adheres to the fishing lure blank 18. The size of the graphic 22 is such that the fishing lure blank 18 will be essentially completely covered by the graphic 22. Moreover, the frame 46 is positioned to place the graphic 22 along a center line through which the fishing lure blank 18 will travel. Thus, the user need not be concerned about proper positioning of the fishing lure blank 18 or the film 20 outside of ensuring that the graphic 22 is centered in the frame 46.

The lure arm 48 is then rotated to move the fishing lure blank 18 out of the water and oscillated to shed excess water. The blower 60 is turned on to further dry the fishing lure blank 18 and the ink of the graphic 22. Once this process is completed, the fishing lure blank 18 may be coated with a clear coat to seal and protect the graphic 22. As would be commonly understood, after the fishing lure blank 18 is dried and protected, hooks are secured onto its eyelets 54.

Typically, the assembly 10 will be utilized with a computer system having the dimensions of the fishing lure blank 18 therein. The computer system may include, for example, software running on a local computer system, a user interactive website, or an application on a mobile device or tablet computer. That is, the fishing lure blank 18 is mapped with a grid pattern from this is created a two-dimensional pattern. Each fishing lure blank 18 is mapped to create a database of differently sized and shaped fishing lure blanks 18. The coordinates of particular features of a fishing lure such as colorations, eyes, fins, and the like can be mapped to corresponding coordinates on the two-dimensional pattern which forms the basis for the graphic 22. This ensures that the graphic 22, when printed, places the markings and coloration in the correct position relative to the fishing lure blank 18 being utilized. The two-dimensional pattern may also include the position of the punch openings in the film 20 through which the prongs 47 will extend. Thus, the graphic 22 will also be properly positioned relative to the reservoir 12 for engaging the fishing lure blank 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A lure decorative film application system including:
a graphic, the graphic having features mapped to correspond to positions on the graphic wherein the graphic is configured to be repeatably produced consistently positioning the features on a dissolvable film for consistent positioning of the features on a fishing lure blank;
a reservoir having a bottom wall and a perimeter wall being attached to and extending upwardly from the bottom wall;
a dipping system being positioned adjacent to the reservoir and being configured to:
engage the fishing lure blank and the dissolvable film;
place the dissolvable film in a quantity of water positioned in the reservoir such that graphic is released onto a surface of the water;
extending the fishing lure blank through the graphic such that the graphic adheres to the fishing lure blank; and
lifting the fishing lure blank upwardly out of the water;
wherein the dipping system includes:
a housing,
a drive assembly being positioned in the housing,
a film arm being attached to the drive assembly, a frame being attached to the film arm, the frame being configured to engage the dissolvable film, the drive assembly moving the frame from a lifted position for supporting the dissolvable film above the reservoir to a lowered positioned extending the dissolvable film into the reservoir and the water in a consistent position relative to the reservoir, and
a lure arm being attached to the drive assembly, a coupler being mounted on the lure arm to releasably engage the fishing lure blank, the drive assembly moving the coupler from a first position above the reservoir and a plane of the surface of the water to a second position into the reservoir and below the plane of the surface of the water in a consistent position relative to the reservoir whereby the graphic is adheres to the fishing lure blank in a consistent position.

2. (canceled)

3. The lure decorative film application system according to claim 1, wherein the dipping system further includes a control circuit being electrically coupled to the drive assembly and a power supply being electrically coupled to the control circuit.

4. The lure decorative film application system according to claim 3, wherein the dipping system further includes an actuator being operationally coupled to the control circuit, a dipping sequence being initiated when the actuator is engaged.

5. The lure decorative film application system according to claim 4, wherein the actuator comprises a switch positioned on the housing.

6. The lure decorative film application system according to claim 4, wherein the control circuit is programmed to complete a plurality of lure and film arm positionings of the dipping sequence, the lure and film arm positioning including first moving the film arm to the lowered position and second moving the lure arm to the second position, the lure arm being moved to the second position after a predetermined dissolving time has elapsed, a time the coupler is in the second position defining a dipping time.

7. The lure decorative film application system according to claim 6, wherein the control circuit is programmed to move the lure arm to the first position after a dipping time has elapsed.

8. The lure decorative film application system according to claim 6, wherein the drive assembly is configured to oscillate the coupler up and down above the reservoir a plurality of times after the dipping time has elapsed to facilitate removal of excess water.

9. The lure decorative film application system according to claim 6, wherein the dipping system further includes a temperature sensor being in thermal communication with the reservoir to measure a temperature of the water, the control circuit being programmed to alter the dissolving time dependent upon the temperature of the water.

10. The lure decorative film application system according to claim 7, wherein the dipping system further includes a blower being mounted in the housing and directing air toward the lure arm when turned on, the blower being electrically coupled to the control circuit and being turned on when the lure arm is lifted from the reservoir.

11. The lure decorative film application system according to claim 6, wherein the dipping system further includes a screen being positioned on the lure arm and positioned such that the coupler is located below the screen when the coupler is within the reservoir, the screen being placed within the reservoir when the lure arm is in the second position and being configured to capture and remove residue floating in the reservoir.

12. The lure decorative film application system according to claim 2, wherein the dipping system further includes a platform being attached to the housing and forming a saddle for removably receiving the reservoir.

13. The lure decorative film application system according to claim 1, wherein the dipping system further includes:
a control circuit being electrically coupled to the drive assembly;
a power supply being electrically coupled to the control circuit;
an actuator being operationally coupled to the control circuit, a dipping sequence being initiated when the actuator is engaged, the actuator comprising a switch positioned on the housing;
the control circuit being programmed to complete a plurality of lure and film arm positionings of the dipping sequence, the lure and film arm positioning including first moving the film arm to the lowered position and second moving the lure arm to the second position, the lure arm being moved to the second position after a predetermined dissolving time has elapsed, a time the coupler is in the second position defining a dipping time;
the control circuit being programmed to move the lure arm to the first position after a dipping time has elapsed;
the drive assembly being configured to oscillate the coupler up and down above the reservoir a plurality of times after the dipping time has elapsed to facilitate removal of excess water;
a temperature sensor being in thermal communication with the reservoir to measure a temperature of the water, the control circuit being programmed to alter the dissolving time dependent upon the temperature of the water;
a blower being mounted in the housing and directing air toward the lure arm when turned on, the blower being electrically coupled to the control circuit and being turned on when the lure arm is lifted from the reservoir;
a screen being positioned on the lure arm and positioned such that the coupler is located below the screen when the coupler is within the reservoir, the screen being placed within the reservoir when the lure arm is in the second position and being configured to capture and remove residue floating in the reservoir; and
a platform being attached to the housing and forming a saddle for removably receiving the reservoir.

14. (canceled)

15. (canceled)

16. (canceled)

17. (canceled)

18. (canceled)
